(19) United States
(12) Patent Application Publication
(10) Pub. No.: US 2009/0328238 A1
(43) Pub. Date: Dec. 31, 2009

(54) Disabling encrypted data

(76) Inventor: David Duncan Ridewood Glendinning, Chandler, AZ (US)

Correspondence Address: Kraguljac & Kalnay, LLC, C/O INTELLEVATE LLC, P.O BOX 52050, MINNEAPOLIS, MN, 55402, US

(21) Appl. No.: 12/152,562

(22) Filed: May 15, 2008

Related U.S. Application Data
(63) Continuation-in-part of application No. 11/824,432, filed on Jun. 29, 2007.

(51) Int. Cl. G06F 21/00; G06F 12/14

(52) U.S. Cl. 726/35; 713/189

(57) ABSTRACT

An apparatus associated with protecting encrypted computing platform data protection is described. One example apparatus includes a theft detection logic to identify when a computing platform has been stolen. The example apparatus also includes a theft deterrence logic to selectively manipulate encryption-related material stored in a secure data store. The theft detection logic may control the theft deterrence logic to hide, delete, or otherwise make unavailable the stored encryption-related material to protect encrypted data associated with the encryption-related material.

### CROSS REFERENCE TO RELATED APPLICATIONS

This application is a continuation-in-part of U.S. patent application Ser. No. 11/824,432 filed Jun. 29, 2007, titled Computer Theft Deterrence Technology, by the same inventor.

### FIELD OF THE INVENTION

Embodiments of the invention relate to the field of data protection. More particularly, at least one embodiment of the invention relates to deleting an encryption key and/or encryption-related material associated with encrypted data stored on a computing platform upon determining that the computing platform has been stolen.

### BACKGROUND

Mobile computing platforms are expensive and thus may be an attractive target for cash-strapped thieves. Mobile computing platforms may also store sensitive information and thus may be an attractive target for another class of thieves. Thus, some computing platforms may encrypt sensitive data in an attempt to prevent unauthorized access to sensitive data after a theft or loss. Data encryption methods employ an encryption key(s) to encrypt and/or decrypt sensitive data on the computing platform. Conventionally, encryption keys may be stored as encrypted binary large objects (BLOBS) on a platform. Thus, a thief who steals the platform may also steal the keys, which ultimately may lead to their being compromised at the leisure of the thief. Encryption keys may also be stored in a secure container (e.g., a trusted platform module (TPM)). Once again, stealing the platform includes stealing the keys in the secure container, which may then be susceptible to compromise at the leisure of the thief.

### BRIEF DESCRIPTION OF THE DRAWINGS

The accompanying drawings, which are incorporated in and constitute a part of the specification, illustrate various example systems, methods, and other embodiments of various aspects of the invention. It will be appreciated that the illustrated element boundaries (e.g., boxes, groups of boxes, or other shapes) in the figures represent one example of the boundaries. One of ordinary skill in the art will appreciate that unless otherwise stated one element may be designed as multiple elements, multiple elements may be designed as one element, an element shown as an internal component of another element may be implemented as an external component and vice versa, and so on. Furthermore, elements may not be drawn to scale.

FIG. 1 illustrates an apparatus to disable encrypted data in accordance with at least some aspects of the invention.

FIG. 2 illustrates an apparatus to disable encrypted data in accordance with at least some aspects of the invention.

FIG. 3 illustrates a method to disable encrypted data in accordance with at least some aspects of the invention.

FIG. 4 illustrates a computer configured with a theft deterrence logic in accordance with at least some aspects of the invention.

### DETAILED DESCRIPTION

One embodiment of the invention provides an apparatus for protecting encrypted data. In one embodiment, the data protection apparatus may include a theft deterrence logic to delete encryption keys and/or other encryption-related material stored in a secure data store based, at least in part, on information provided by a theft detection logic. The theft detection logic may control the data protection to occur without receiving an activation signal from an external source. The theft detection logic, theft deterrence logic, and secure data store may reside in an integrated embedded controller implemented in firmware in a member of a computing platform's chipset. The encryption key and/or encryption-related material may be associated with data residing outside the integrated embedded controller (e.g., on disk) on the computing platform. When a theft and/or loss state are identified, the theft deterrence logic may hide or delete the encryption-related material in the data store. This may prevent the encryption-related material from becoming found and/or compromised.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Data store”, as used herein, refers to a physical and/or logical entity that can store data. A data store may be, for example, a database, a table, a file, a list, a queue, a heap, a memory, a register, a disk, and so on. In different examples, a data store may reside in one logical and/or physical entity and/or may be distributed between multiple logical and/or physical entities.

“Logic”, as used herein, includes but is not limited to hardware, firmware, software in execution, and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combination of gates, other circuit components, and so on.

“Signal”, as used herein, includes but is not limited to, electrical signals, optical signals, analog signals, digital signals, data, computer instructions, processor instructions, messages, a bit, a bit stream, or other means that can be received, transmitted, and/or detected.

Some portions of the detailed descriptions that follow are presented in terms of algorithm descriptions and representations of operations on electrical and/or magnetic signals capable of being stored, transferred, combined, compared, and otherwise manipulated in hardware. These are used by those skilled in the art to convey the substance of their work to others. An algorithm is here, and generally, conceived to be a sequence of operations that produce a result. The operations may include physical manipulations of physical quantities (e.g., electrical, magnetic). It has proven convenient to refer to these electrical and/or magnetic signals as bits, values, elements, symbols, characters, terms, numbers, protocol messages, and so on. It is appreciated that terms including processing, computing, calculating, determining, displaying, automatically performing an action, and so on, refer to actions and processes of a computer system, logic, processor, or similar electronic device that manipulates and transforms data represented as physical (electric, electronic, magnetic) quantities.

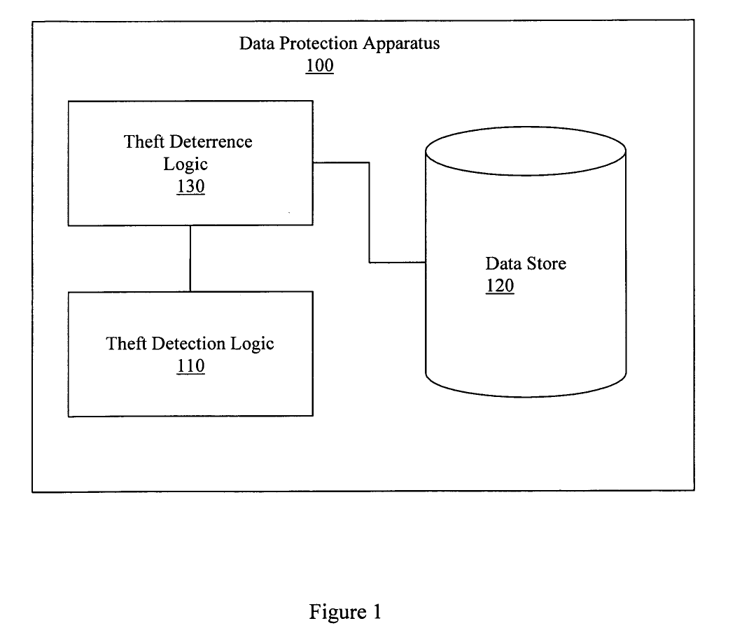

FIG. 1 illustrates an apparatus 100 for protecting encrypted data on a computing platform. The protection may include disabling encrypted data by deleting encryption-related material stored in a secure data store 120. The protection may be invoked upon detecting a theft of the computing platform. While a “theft” is described, it is to be appreciated that theft and loss states may be treated similarly. The apparatus 100 may include a theft detection logic 110 for determining whether the computing platform has been stolen. The theft detection logic 110 may manipulate a value (e.g., stolen state value) upon determining that a computing platform housing apparatus 100 has been stolen. Additionally and/or alternatively, the theft detection logic 110 may provide a signal identifying the theft state. Theft detection logic 110 may determine that a platform has been stolen based on signals received and/or not received from an external security provider.

Theft detection logic 110 may include, for example, a security timer. The security timer may be periodically reset by a signal from an external security provider (ESP). If the security timer times out without being reset, then theft detection logic 110 may determine that the platform has been stolen and may, for example, manipulate a state variable to reflect the stolen condition, generate a signal related to the state, and so on. The ESP may not provide a signal to update a security timer associated with the theft detection logic 110 upon determining that the computing platform housing the apparatus 100 has been stolen. The ESP may determine that the computing platform has been stolen based, for example, on an email from the owner of the computing platform, on a phone call from the owner of the computing platform, on other communications from entities authorized to report the platform stolen, and so on.

Apparatus 100 may also include a data store 120 to securely store an encryption key. While “encryption-related material” is described, it is to be appreciated that actual “encryption keys” could be stored. The encryption-related material may be used to decrypt, for example, a previously encrypted item (e.g., binary large object (BLOB)). Thus, as used herein, “encryption-related material” refers to an encryption key and/or other material used to decrypt a previously encrypted item. The encryption-related material may have been provided by the computing platform to be protected by apparatus 100. The encryption-related material may be related to the encrypted data stored in a less secure area of the computing platform. The less secure area may be, for example, a hard disk drive. Data on the hard disk drive may be encrypted using encryption-related material (e.g., encryption key) and then secure data store 120 may be entrusted with storing the encryption-related material. Apparatus 100 may manipulate (e.g., prevent access to, delete the contents of) the encryption-related material stored in secure data store 120 upon determining that theft detection logic 110 has identified a stolen state.

Apparatus 100 may also include a theft deterrence logic 130. Theft deterrence logic 130 may selectively manipulate information (e.g., encryption key, encryption-related material) in data store 120 based, at least in part, on information provided by the theft detection logic 110. The theft detection logic 110 may, for example, provide or make available a value of a state variable to the theft deterrence logic 130. The theft detection logic 110 may, additionally and/or alternatively, provide a signal to theft deterrence logic 130 and/or control theft deterrence logic 130. Theft deterrence logic 130 may prevent access to, hide, and/or delete information in the data store 120 upon determining that a platform theft condition exists. The theft detection logic 110, the data store 120, and the theft deterrence logic 130 may reside in a member of a chipset of the computing platform. In one example, the member of the chipset may be a memory controller hub (MCH). Note that the encryption-related material need not be stored in its entirety in the secure data store 120. In different examples, a portion of different types of materials could be stored in the secure data store 120. For example, an initialization vector, a portion of a key, and so on, could be used in conjunction with an externally supplied material (e.g., passphrase) that, when algorithmically combined result in a disk encryption key being revealed. Thus, an item(s) stored in the secure data store 120 and/or in apparatus 100 may be used by itself in one configuration but could be used in conjunction with an externally provided material in a different configuration.

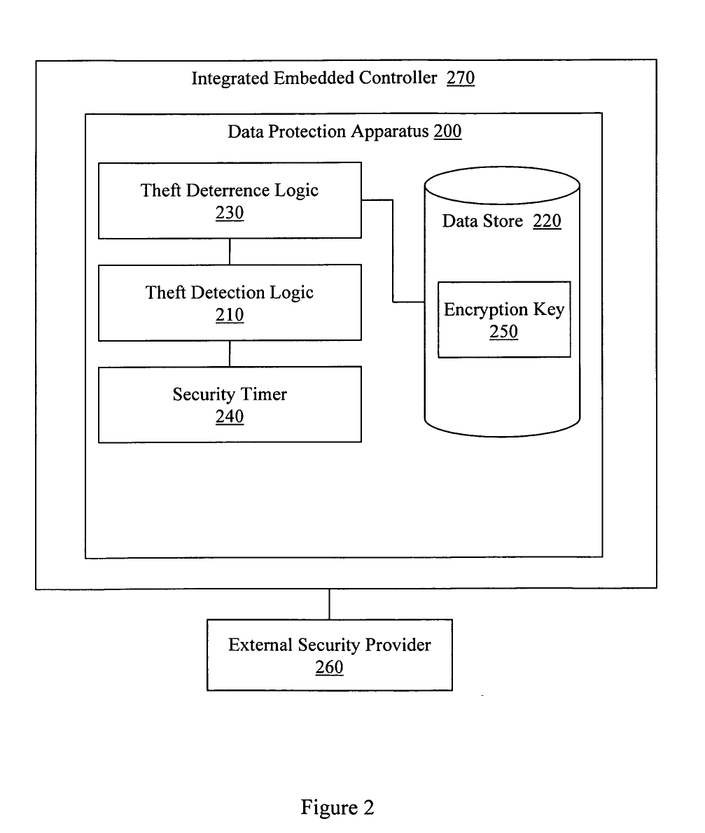

FIG. 2 illustrates an apparatus 200 for protecting encrypted data on a mobile computing platform (e.g., laptop). Some components of apparatus 200 may reside in an integrated embedded controller 270 in the computing platform. Apparatus 200 may include a security timer 240, a secure data store 220, a theft detection logic 210, and a theft deterrence logic 230. Security timer 240 may be periodically reset by a signal from an ESP 260. ESP 260 may selectively not provide the signal to update the security timer 240 upon determining that the computer housing the apparatus 200 has been stolen. Secure data store 220 may house an encryption key 250 provided by the computing platform. While an encryption key 250 is illustrated, it is to be appreciated that secure data store 220 may, more generally, store encryption-related material. The encryption-related material may be, for example, material used to decrypt a previously encrypted item (e.g., BLOB). Theft deterrence logic 230 may prevent access to, hide, and/or delete an encryption key 250 and/or other encryption-related material in the event that theft conditions are detected.

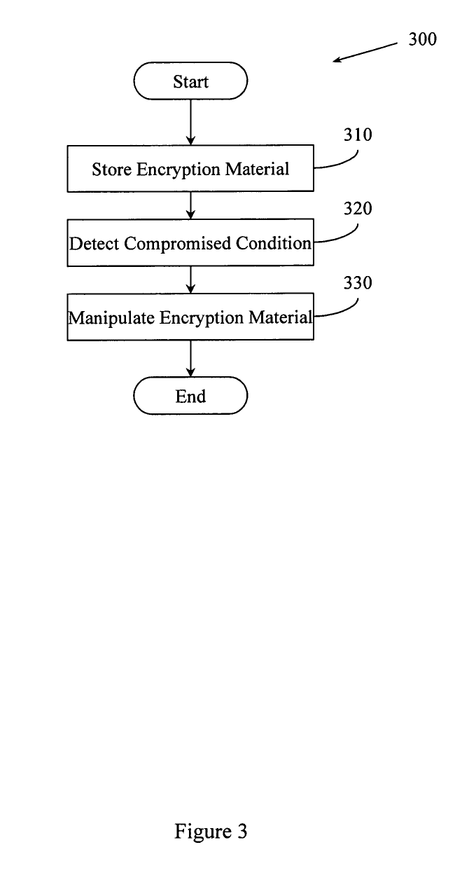

FIG. 3 illustrates a method 300 associated with protecting encrypted data on a stolen computing platform. Method 300 may include, at 310, storing encryption-related material in a data store that is unavailable to an operating system associated with a computing platform for which the method provides protection for encrypted data. The encryption-related material may be associated with encrypted data available to the operating system. In one example, storing the encryption-related material may include storing it in a memory controller hub associated with the computing platform. The memory controller hub may house firmware that implements, for example, an integrated embedded controller.

Method 300 may also include, at 320, detecting a compromised condition related to the computing platform. In one example, detecting the compromised condition includes monitoring a timer that is periodically refreshed by an external refresh signal that is provided while the computing platform is not in the compromised condition. The compromised condition may be, for example, a stolen condition, a lost condition, a damaged condition, and so on.

Method 300 may also include, at 330, selectively manipulating the encryption-related material upon detecting the compromised condition. In one example, manipulating the encryption-related material may include deleting the encryption-related material. To facilitate handling erroneously reported compromised conditions and/or to facilitate undoing the effects of deleting encryption-related material, method 300 may also include providing a copy of the encryption-related material to an external security provider. This copy may itself be encrypted using previously agreed upon encryption-related material that is stored at the external security provider. In this way, encrypted data may be recovered if the computing platform is recovered. This may occur, for example, when a computing platform is reported stolen but was actually simply misplaced and later recovered.

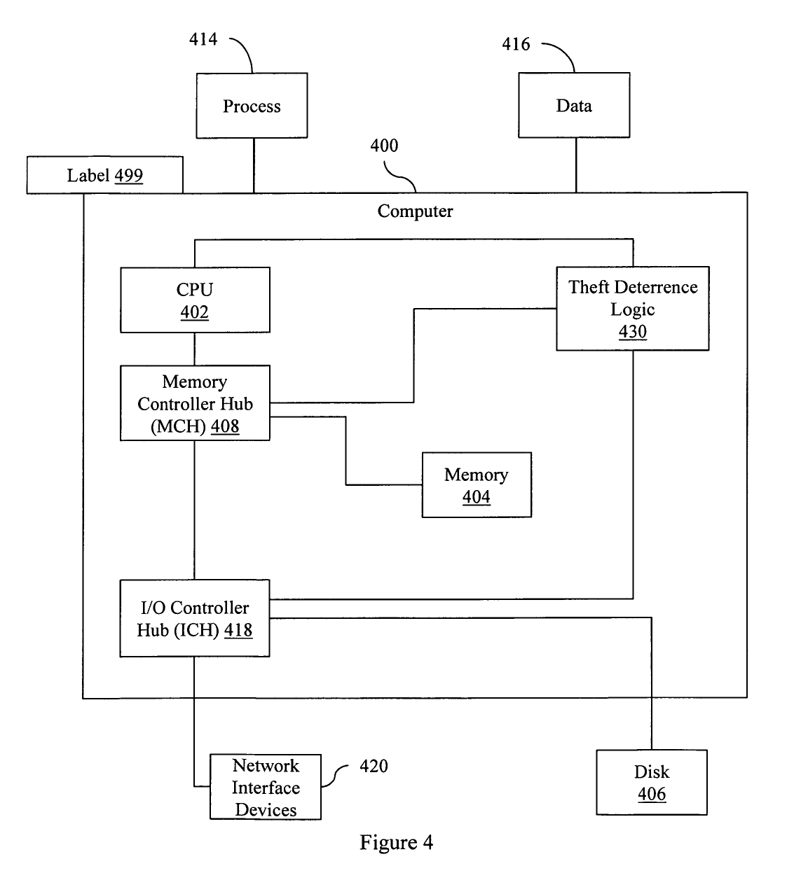

FIG. 4 illustrates a computer 400 having a theft deterrence logic 430 and a label 499. Theft deterrence logic 430 may implement embodiments of various systems and methods described herein in accordance with at least some aspects of the invention and label 499 may provide indicia that computer 400 has a theft deterrence system (TDS). In different embodiments, the logic 430 may be implemented in hardware, software in execution, firmware, and/or combinations thereof. In some embodiments, the software may include computer instructions and/or processor instructions. Software may cause a computer, processor, or other electronic device to perform functions, actions and/or behave in a desired manner. In different embodiments, computer-readable and/or executable instructions may be located in one logic and/or distributed between multiple communicating, co-operating, and/or parallel processing logics and thus may be loaded and/or executed in serial, parallel, massively parallel and other manners.

Computer 400 may include a central processing unit (CPU) 402 and a memory 404. A disk 406 may be operably connected to the computer 400 via, for example, an input/output controller hub (ICH) 418. The computer 400 can operate in a network environment and thus may be connected to network interface devices 420 via the ICH 418. The memory 404 can store a process 414 and/or a data 416, for example. The disk 406 and/or the memory 404 can interact with and be available to an operating system that controls and allocates resources of the computer 400. Thus, either memory 404 and/or disk 406 may store encrypted data. Encryption-related material associated with encrypting the data may be stored in theft deterrence logic 430. Items stored in theft deterrence logic 430 may not be available to an operating system associated with computer 400. Thus, compromising the operating system may not lead to compromising the encrypted data.

The computer 400 may include a memory controller hub (MCH) 408 to operably connect the CPU 402, memory 404, ICH 418, and theft deterrence logic 430. In some embodiments, an “operable connection” or a connection by which entities are “operably connected”, is one in which signals, physical communications, and/or logical communications may be sent and/or received. An operable connection may include a physical interface, an electrical interface, and/or a data interface. In some embodiments, example data protecting apparatus may be integrated into the MCH 408 to provide a secure storage and code execution environment. Thus, in some embodiments, logic 430 may be integrated into MCH 408.

Computer 400 may be, for example, a mobile platform (e.g., laptop, notebook) that has an integrated embedded controller (IEC). In some embodiments, the IEC may be integrated into a chipset to provide a secure data storage and code execution environment that is less susceptible to unauthorized manipulation than higher level (e.g., operating system) mechanisms. The IEC may implement an internal secure timer and may be configured to communicate with an external policy server (PS) at a policy based time interval. The communication may request authorization to reset the internal secure timer. The authorization may be provided when the computer is in a “not stolen” state. The internal secure timer and the TDS allow a computer to function normally as long as the timer does not time out. If the computer is stolen, then a user-initiated action (e.g., reporting theft) may cause the computer to enter a “stolen” state at the external PS. When the computer is in the stolen state, then the PS may not respond to the computer request for a timer refresh, in which case the internal secure timer may time out. When the timer times out, the computer may become disabled. Over time, market awareness may develop with respect to TDS-configured computers becoming disabled after being stolen, which may make such computers less attractive targets.

Note that the communications between the IEC and the PS may be operating system independent. The IEC may be part of a comprehensive set of tools that facilitate both in-band and out-of-band communication and management. In some embodiments, the IEC may be part of an active management logic that facilitates discovering, healing, and protecting computing assets independent of an operating system. Thus, the IEC may be viewed as a separate system that operates independent of the operating system. Therefore, when computer 400 has a TDS that relies on an IEC rather than on an operating system, computer 400 may not be vulnerable to operating system reinstallation, or nonvolatile mass storage device (e.g., disk drive) replacement followed by operating system reinstallation.

What is claimed is:

1. An apparatus, comprising:
a theft detection logic to make a determination concerning whether a computing platform associated with the apparatus has been stolen;
a data store to store an encryption-related material related to encrypted data stored on the computing platform; and
a theft deterrence logic to selectively manipulate the encryption-related material based, at least in part, on the determination by the theft detection logic;
where the data store resides in a member of a chipset of the computing platform, where the member provides a portion of a secure, operating system independent execution environment for the computing platform.

2. The apparatus of claim 1, where the theft detection logic includes a security timer that may be periodically reset by a reset signal provided by an external security provider (ESP), and where the theft detection logic will determine that the computing platform has been stolen upon the expiration of the security timer.

3. The apparatus of claim 2, where the ESP will selectively not provide the reset signal when the ESP considers the computing platform to be in a stolen state.

4. The apparatus of claim 3, where the ESP is to consider the computing platform to be in a stolen state upon receiving a communication concerning the computing platform from an entity authorized to report the computing platform stolen.

5. The apparatus of claim 1, where the theft detection logic and the theft deterrence logic are implemented in firmware in the member of the chipset and form a portion of the secure, operating system independent execution environment.

6. The apparatus of claim 5, where the secure, operating system independent execution environment provides in-band and out-of-band communications for the computing platform and facilitates discovering, healing, and protecting computing assets of the computing platform.

7. The apparatus of claim 6, where the member of the chipset is the memory controller hub.

8. The apparatus of claim 1, where the theft deterrence logic is to perform one or more of, preventing access to the encryption-related material, hiding the encryption-related material, and deleting the encryption-related material based, at least in part, on the determination made by the theft detection logic.

9. The apparatus of claim 1, where the theft detection logic is to perform one or more of, manipulating a state variable, generating a signal, and controlling the theft deterrence logic based, at least in part, on the determination made by the theft detection logic.

10. The apparatus of claim 1, where the theft detection logic includes a security timer that may be periodically reset by a reset signal provided by an external security provider (ESP), where the ESP will selectively not provide the reset signal when the ESP considers the computing platform to be in a stolen state, where the ESP is to consider the computing platform to be in a stolen state upon receiving a communication concerning the computing platform from an entity authorized to report the computing platform stolen, and where the theft detection logic will determine that the computing platform has been stolen upon the expiration of the security timer;
where the theft detection logic and the theft deterrence logic are implemented in firmware in the member of the chipset and form a portion of the secure, operating system independent execution environment, where the secure operating system independent execution environment provides in-band and out-of-band communications for the computing platform and facilitates discovering, healing, and protecting the computing assets of the computing platform;
where the member of the chipset is the memory controller hub;
where the theft deterrence logic is to perform one or more of, preventing access to the encryption-related material, hiding the encryption-related material, deleting the encryption-related material, manipulating a state variable, generating a signal, and controlling the theft deterrence logic based, at least in part, on the determination made by the theft detection logic.

11. A method, comprising:
storing an encryption-related material in a data store that is unavailable to an operating system associated with a computing platform for which the method provides protection for encrypted data, the encryption-related material being associated with encrypted data available to the operating system;
detecting a compromised condition related to the computing platform; and
selectively manipulating the encryption-related material upon detecting the compromised condition.

12. The method of claim 11, where storing the encryption-related material includes storing the encryption-related material in a memory controller hub associated with the computing platform.

13. The method of claim 11, where detecting the compromised condition includes monitoring a timer that is periodically refreshed by an external refresh signal that is provided while the computing platform is not in the compromised condition.

14. The method of claim 11, where manipulating the encryption-related material includes deleting the encryption-related material.

15. The method of claim 14, including providing a copy of the encryption-related material to an external security provider.
